(19) United States
(12) Patent Application Publication
(10) Pub. No.: US 2008/0280120 A1
(43) Pub. Date: Nov. 13, 2008

(54) Thermally Insulating Molded Element

(75) Inventors: Frank Fechner, Lemforde (DE); Ralf Fritz, Greifenberg (DE); Anja Biedermann, Diepholz (DE); Jorg Krogmann, Lohne (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 10/571,915

(22) PCT Filed: Sep. 8, 2004
(86) PCT No.: PCT/EP2004/010017

§ 371 Date: Mar. 14, 2006

(30) Foreign Application Priority Data
Sep. 15, 2003 (DE) 103 42 859.3

(51) Int. Cl. B32B 3/26; B29C 47/00

(52) U.S. Cl. 428/304.4; 264/101

(57) ABSTRACT

The invention relates to moldings which comprise a rigid compact polyurethane or a rigid polyurethane foam having a compact outer skin and a cellular core and contain at least one vacuum insulation panel.

The present invention relates to moldings for thermal insulation which contain at least one vacuum insulation panel.

Vacuum insulation units, also referred to as vacuum insulation panels, are being used to an increasing extent for thermal insulation. They are employed, inter alia, for housings of refrigeration appliances, containers for refrigerated vehicles, coolboxes, cold storage cells or long-distance heating pipes. Owing to their low thermal conductivity, they offer advantages over conventional insulating materials. Thus, the energy savings potential compared to closed-celled rigid polyurethane foams is usually about 20-30%.

Such vacuum insulation units generally comprise a thermally insulating core material, for example open-celled rigid polyurethane (PUR) foam, open-celled extruded polystyrene foam, silica gels, glass fibers, loose beds of polymer materials, pressed comminuted rigid or semirigid PUR foam, perlite, which is packed in a gastight film, evacuated and hermetically sealed. The pressure should be less than 100 mbar. At this vacuum, a thermal conductivity of the panels of less than 10 mW/mK can be achieved, depending on the structure and pore size of the core material.

For thermal insulation purposes, the vacuum insulation panels are usually introduced into the component to be insulated and fixed there. The above-described components for thermal insulation usually comprise two compact layers, preferably metal sheets or plastics such as polystyrene.

EP 434 225 describes the customary industrial method of producing components for thermal insulation. For this purpose, the vacuum insulation panel is adhesively bonded to at least one of the side walls and the remaining hollow space is filled with rigid polyurethane foam, since it would otherwise act as a heat bridge. In addition, filling with foam is necessary to establish the bond between the two side walls of the component.

It is not possible to omit one of the two side walls, since water vapor would otherwise diffuse into the rigid polyurethane foam, which would result in a large increase in the thermal conductivity.

A disadvantage of this and similar methods is that the fixing of the vacuum insulation panels to the side walls represents an additional working step. Since damage to the vacuum insulation panels has to be avoided at all costs, the installation and fixing in the component is usually carried out manually.

A further disadvantage is that two insulation materials having a differing insulation behavior are used in this procedure. As a result, the potential of the vacuum insulation panels cannot be fully realized.

It is an object of the present invention to develop moldings for thermal insulation which have a very low thermal conductivity and are simple to produce.

We have found that this object is achieved by enveloping a vacuum insulation panel completely with a rigid compact polyurethane or a rigid polyurethane foam having a compact external skin and cellular core.

The present invention accordingly provides a molding comprising a rigid compact polyurethane or a rigid polyurethane foam having a compact outer skin and a cellular core and containing at least one vacuum insulation panel.

The present invention further provides a process for producing moldings comprising a rigid compact polyurethane or a rigid polyurethane foam having a compact outer skin and a cellular core and containing at least one vacuum insulation panel, which comprises
a) introducing at least one vacuum insulation panel into a mold,
b) filling the mold with the starting components for a rigid compact polyurethane or a rigid polyurethane foam having a compact outer skin and a cellular core,
c) closing the mold,
d) taking the molding from the mold after curing of the rigid compact polyurethane or the rigid polyurethane foam having a compact outer skin and a cellular core.

The present invention also provides for the use of the moldings of the present invention for producing cold storage equipment. Cold storage equipment includes refrigeration appliances such as refrigerators or freezer chests, refrigerated vehicles, coolboxes, cold storage cells or long-distance heating pipes.

To produce the moldings of the present invention, it is possible to use customary and known vacuum insulation panels. They are produced, as described above, by enveloping a thermally insulating core material, for example open-celled rigid polyurethane (PUR) foam, open-celled extruded polystyrene foam, silica gels, glass fibers, loose beds of polymer material, pressed comminuted rigid or semirigid PUR foam, perlite, in a gastight film, evacuation and hermetic sealing, usually by welding or adhesive bonding. The pressure in the vacuum insulation panel should be less than 100 mbar. To maintain the vacuum over a prolonged period of time, it is customary for getter materials, for example activated carbon, to be additionally introduced into the vacuum insulation panels. Such vacuum insulation panels are described, for example, in WO 97/36129 or WO 99/61503.

The rigid polyurethane foams having a compact external skin and a cellular core, also referred to as rigid polyurethane integral foams, which are used for producing the moldings of the present invention, their production and use are described, for example, in the Kunststoffhandbuch, volume 7 “Polyurethane”, 3rd edition 1993, Carl Hanser Verlag, Munich, Vienna, in chapter 7.4. The rigid compact polyurethanes differ from the rigid polyurethane integral foams in that no blowing agents are used in the formulation.

Such polyurethanes are usually produced by reacting polyisocyanates, in particular diphenylmethane 4,4′-diisocyanate or its derivatives, with short-chain polyether alcohols in the presence of catalysts, blowing agents and, if required, crosslinkers and auxiliaries and/or additives.

These polyurethanes are usually used for producing housings, sports equipment, in particular skis, and for furniture.

As regards the starting compounds used for producing the rigid compact polyurethanes or rigid polyurethane foams having a compact outer skin and a cellular core, the following details may be provided:

As polyisocyanates, it is in principle possible to use all known and customary aliphatic and in particular aromatic isocyanates having at least two isocyanate groups in the molecule. Rigid polyurethane integral foams are usually produced using diphenylmethane diisocyanate or mixtures of diphenylmethane diisocyanate with polyphenylenepolymethylene polyisocyanates. The isocyanates can be used as pure compounds or in modified form. The polyisocyanates can be modified, for example, by incorporation of allophanate, urethane or isocyanurate groups.

As compounds having at least two hydrogen atoms which are reactive toward isocyanate groups, preference is given to using polyether alcohols and/or polyester alcohols.

The polyether alcohols have, in particular, a functionality in the range from 2.5 to 5, preferably from 2.5 to 4. The molar mass (M_{w}) of the polyether alcohols is preferably in the range from 150 to 650, in particular from 200 to 600, and their viscosity at 25° C. is preferably in the range from 250 to 7000 mPa·s, in particular from 350 to 6500 mPa·s, determined in accordance with DIN 53019. These polyether alcohols are prepared by generally known methods, in particular by addition of lower alkylene oxides, preferably propylene oxide and/or ethylene oxide, onto H-functional starter substances. Preferred starter substances are 3- to 5-functional alcohols or amines, for example glycerol, trimethylolpropane, pentaerythritol, sorbitol or ethylenediamine or any mixtures of alcohols and/or amines.

As polyester alcohols, particular preference is given to using those having a hydroxyl number in the range from 150 to 350 mg KOH/g and a viscosity at 25° C., determined in accordance with DIN 53019, in the range from 2000 to 10 000 mPa·s.

They are prepared according to known methods by reacting polyfunctional carboxylic acids with polyfunctional alcohols. Polyfunctional carboxylic acids are, in particular, dicarboxylic acids and/or their derivatives, preferably phthalic acid, phthalic anhydride or adipic acid. Polyfunctional alcohols used are especially diols, for example ethylene glycol and its higher homologues, propylene glycol and its higher homologues, butanediols or higher alkanediols, in particular those having up to 10 carbon atoms in the alkane chain. To increase the functionality of the polyester alcohols, small amounts of trifunctional or higher-functional alcohols can also be used.

It is usual to use exclusively polyether alcohols as compounds having at least two hydrogen atoms which are reactive toward isocyanates. It is in this case possible to use only one polyether alcohol or a mixture of at least two polyether alcohols.

Apart from the above-described polyether alcohols and polyester alcohols, it is also possible to use chain extenders and crosslinkers as compounds having at least two hydrogen atoms which are reactive toward isocyanate groups. These are low molecular weight H-functional compounds. The molecular weight of these compounds is in the range from 62 and that of the above-described polyether alcohols and polyester alcohols. Chain extenders used are usually diols, and crosslinkers used are usually trifunctional alcohols and/or amines.

In the case of rigid polyurethane integral foams, the process of the present invention is carried out in the presence of blowing agents, catalysts and, if required, auxiliaries and/or additives.

As blowing agent, it is possible, for example, to use water which reacts with isocyanate groups to eliminate carbon dioxide. It is also possible to use physical blowing agents in place of but preferably in combination with water. These are compounds which are inert toward the starting components and are usually liquid at room temperature and vaporize under the conditions of the urethane reaction. The boiling point of these compounds is preferably below 110° C., in particular below 80° C. Physical blowing agents also include inert gases which are introduced into the starting components or are dissolved therein, for example carbon dioxide, nitrogen or noble gases.

The compounds which are liquid at room temperature are usually selected from the group consisting of alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples of physical blowing agents are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane. The physical blowing agents mentioned can be used alone or in any combinations with one another.

Catalysts used are, in particular, compounds which strongly accelerate the reaction of the isocyanate groups with the groups which are reactive toward isocyanate groups. Particular preference is given to using organic metal compounds, especially organic tin compounds such as tin(II) salts of organic acids.

It is also possible to use strongly basic amines as catalysts. Examples of such compounds are secondary aliphatic amines, imidazoles, amidines, triazines and alkanolamines.

The catalysts can, depending on requirements, be used alone or in any mixtures with one another.

As auxiliaries and/or additives, use is made of the substances known per se for this purpose, for example surface-active substances, foam stabilizers, cell regulators, fillers, for example mineral fillers such as chalk or barite, or hollow microspheres, pigments, dyes, flame retardants, hydrolysis inhibitors, antistatics, fungistatic and bacteriostatic agents.

To produce the moldings of the present invention, the polyisocyanates and the compounds having at least two hydrogen atoms which are reactive toward isocyanate groups are mixed and introduced into a mold into which a vacuum insulation panel has been introduced beforehand. After the formative components have been introduced, the mold is closed and the polyurethane is allowed to cure. After curing, the mold is opened and the molding is taken out.

The reaction of the polyisocyanate with the compounds having at least two hydrogen atoms which are reactive toward isocyanate groups is preferably carried out at an isocyanate index in the range from 90 to 150, particularly preferably from 95 to 130.

It is customary in industry to combine the compounds having at least two hydrogen atoms which are reactive toward isocyanate groups with the chain extenders, the crosslinkers, catalysts, blowing agents and the auxiliaries and/or additives to form a polyol component and to react this with the polyisocyanates. However, it is also possible in principle to introduce all or some of the abovementioned starting materials individually.

The mixing of the reaction components prior to introduction into the mold can in the simplest case be carried out by manual stirring. However, it is customary in industry to carry out mixing by means of metering devices, usually mixing heads. Such devices are generally known and commercially available.

The temperature at which the mixture is cured to form the polyurethane is preferably in the range from 40 to 130° C.

The rigid polyurethane foams having a compact outer skin and a cellular core which are used for the moldings of the present invention usually have a density in the range from 200 to 800 kg/m³, preferably from 200 to 700 kg/m³. The density of the compact polyurethanes is preferably in the range from 700 to 1200 kg/m³.

The moldings of the present invention can be produced in the shape required for the respective application. Machining after removal from the mold is no longer necessary. The vacuum insulation panel is preferably surrounded completely by the rigid compact polyurethane or the rigid polyurethane foam having a compact outer skin and a cellular core.

Since the moldings are self-supporting, installation in metal or plastic housings, as in conventional cold storage containers, is not necessary. The film surrounding the panel is impermeable to water vapor, so that there is also no diffusion of water vapor into the interior of the vacuum insulation panel.

Openings for fittings such as door handles, hinges or the like can be produced in the moldings during molding, so that they can readily be assembled to produce the desired components for thermal insulation.

The compact polyurethanes and rigid polyurethane foams having a compact outer skin and a cellular core can be colored by adding dyes to at least one of the formative components. It is also possible for the surfaces of the moldings of the present invention to be provided with a surface coating.

In a preferred embodiment of the invention, one of the sides, preferably the interior side, can be a layer of metal or plastic. This is particularly preferred when it is important that the interior be able to be cleaned readily. In this case, this layer is also placed in the mold. This can occur before introduction of the formative components or prior to closing the mold.

The moldings of the present invention have a very low thermal conductivity. They are simple to produce, are mechanically stable and have a low weight.

The invention is illustrated by the following examples.

### EXAMPLE 1

A vacuum insulation panel having dimensions of 596×1196×36 mm is introduced into a mold having the dimensions 600×1200×40 mm and fixed in place. The mold is then closed and 3000 g of polyurethane system are introduced into the mold.

The polyurethane system had the following composition:

Polyol component: a mixture of

19.36 parts by weight of a graft polyol having a hydroxyl number of 20 mg KOH/g and prepared by in-situ polymerization of styrene and acrylonitrile in a glycerol-started polyether alcohol comprising ethylene oxide and propylene oxide,

25.97 parts by weight of a polyether alcohol having a hydroxyl number of 27 mg KOH/g and prepared by addition of ethylene oxide and propylene oxide onto glycerol,

20.0 parts by weight of a polyether alcohol having a hydroxyl number of 750 mg KOH/g and prepared by addition of propylene oxide onto ethylenediamine,

10.0 parts by weight of dipropylene glycol,

10.0 parts by weight of diethylene glycol,

8 parts by weight of an internal mold release agent,

3 parts by weight of Dabco® 33 LV as catalyst,

6 parts by weight of black paste and

0.15 part by weight of water;

Isocyanate: Lupranat M20W® from BASF AG

The reaction was carried out at an index of 110. After 200 s, the part was removed from the mold.

The foam used had a free-foamed density of 600-700 g/l.

The resulting molding had a compact outer skin and a cellular core.

We claim:

1. A molding comprising a rigid compact polyurethane or a rigid polyurethane foam having a compact outer skin and a cellular core and containing at least one vacuum insulation panel.

2. A molding as claimed in claim 1, wherein the vacuum insulation panel is completely surrounded by the rigid compact polyurethane or a rigid polyurethane foam having a compact outer skin and a cellular core.

3. A molding as claimed in claim 1, wherein the rigid polyurethane foam having a compact outer skin and a cellular core has a density in the range from 200 to 800 kg/m³.

4. A molding as claimed in claim 1 which has openings for fittings.

5. A molding as claimed in claim 1 which is self-supporting.

6. A process for producing moldings comprising a rigid compact polyurethane or a rigid polyurethane foam having a compact outer skin and a cellular core and containing at least one vacuum insulation panel, which comprises
a) introducing at least one vacuum insulation panel into a mold,
b) filling the mold with the starting components for a rigid compact polyurethane or a rigid polyurethane foam having a compact outer skin and a cellular core,
c) closing the mold,
d) taking the molding from the mold after curing of the rigid compact polyurethane or the rigid polyurethane foam having a compact outer skin and a cellular core.

7. The use of a molding as claimed in claim 1 for producing refrigeration appliances.

8. The use of a molding as claimed in claim 1 for producing refrigerators, freezer chests, refrigerated vehicles, coolboxes, cold storage cells or long-distance heating pipes.
